(19) United States
(12) Patent Application Publication
(10) Pub. No.: US 2018/0025675 A1
(43) Pub. Date: Jan. 25, 2018

(54) Quick Release/Placement Identification Card Holder for Automobiles

(71) Applicant: Eric Douglas Sparks, Highlands Ranch, CO (US)

(72) Inventor: Eric Douglas Sparks, Highlands Ranch, CO (US)

(21) Appl. No.: 15/655,884

(22) Filed: Jul. 21, 2017

Related U.S. Application Data
(60) Provisional application No. 62/365,999, filed on Jul. 23, 2016.

(51) Int. Cl. G09F 3/20

(52) U.S. Cl. CPC G09F 3/20

(57) ABSTRACT

A flexible, thin pouch sized to fit in a clothing pocket that includes an open side to insert and remove contents. Additional features such as one face that includes a hole to aide with inserting and removing contents. An opposite face that includes a non-damaging, non-perforating, quick release method of attachment, such that it can be affixed and removed quickly and repetitively to a hard surface with one hand, without the use of tools, without degradation of performance.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Technical Field

The present invention relates to a pouch.

### Description of Related Art

Pouches are common place and are used in a wide variety of applications. Pouches range from wallets, to workplace badge holders, to small purses. Although there are existing pouches intended to hold identification cards and small pieces of paper, none exist that can be quickly affixed or removed from a hard surface, such as an automotive interior door panel a seemingly infinite number of times as the present invention is capable of. In addition, no such pouches exist that can be affixed or removed from a hard surface inside an automobile with one hand without the use of tools or an additional device and that are as thin in profile as the present invention.

There are devices, such as those described in U.S. Pat. No. 4,588,094A, that are capable of holding multiple documents while being affixed to hard vertical surfaces. However, these devices, as with other types of hanging wall folders are not capable of being quickly affixed and removed by one hand without the use of tools. In addition, their large size prevents them from fitting on automotive door panels and in one's clothing pocket.

There are devices, such as those described in U.S. Pat. No. 5,904,389A, that are intended to provide secure storage within one's automobile for items, documents, or both. However, these devices aren't capable of being quickly removed or affixed from/to the automobile by one hand without the use of tools. They are also incapable of displaying their contents for those outside the vehicle, when in the closed position. They are also incapable of being placed in one's clothes pocket due to their large size.

There are devices, such as those described in U.S. Pat. No. 9,339,094B2, that are capable of holding small documents securely and are also of a size to be placed in one's clothing pocket. However, these devices, as with other wallets are incapable of being quickly affixed and removed from a hard surface such as an automotive door panel or dashboard, by one hand without the use of tools.

### BRIEF SUMMARY OF THE INVENTION

A quick release pouch that can be affixed temporarily or permanently to the interior of an automobile. It is comprised of a small pouch, capable of holding an identification card, such as a driver's license, automobile registration, and proof of insurance that can be quickly affixed and removed from a hard surface within the interior of an automobile with one hand, without the use of tools since it includes a non-damaging/non-perforating method of mounting such as hook and loop, non-damaging adhesive, magnets or combination thereof. The pouch itself is open on one side, allowing its contents to be removed or inserted quickly without the use of tools. The pouch may also contain a small hole through one face, allowing an individual to more easily slide the contents out with their fingers or thumb. The pouch is sized and shaped to hold its contents tightly and to fit within one's clothing pocket, while still allowing the quick removal and insertion of the pouches contents. The pouches size, likely contents, and other features described herein, allow it to be located on surfaces, such as an automotive door panel or dashboard, allowing those outside the automobile to see the pouch with an unobstructed view.

### BRIEF DESCRIPTION OF THE SEVERAL VIEWS OF THE DRAWINGS

FIG. 1 is a front view, showing all of the features of the present invention

FIG. 2 is a front view, showing a potential installation location of the present invention

### DETAILED DESCRIPTION OF THE INVENTION

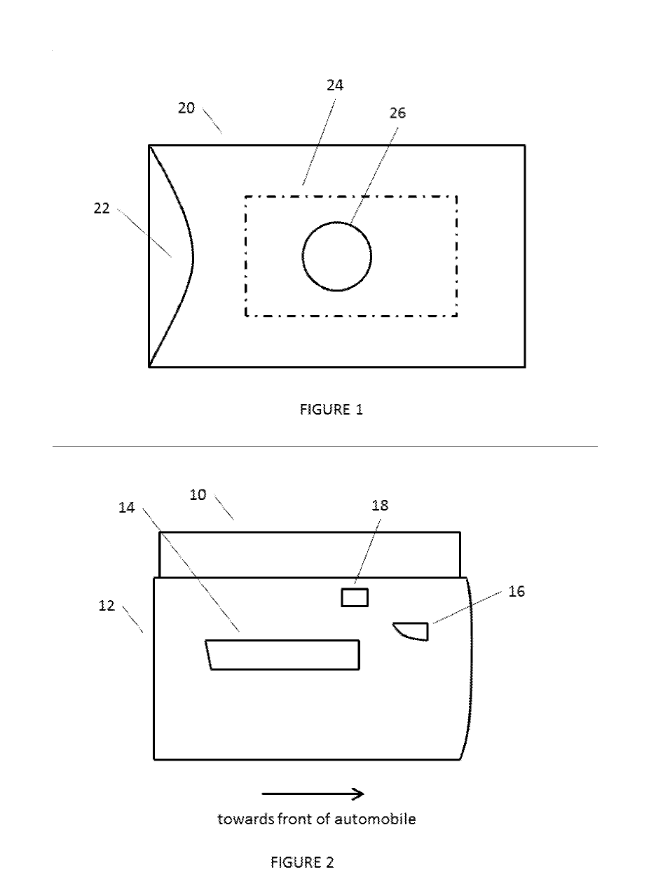

FIG. 1 shows the present invention and all of its features. Pouch 20 contains an opening on one edge of the pouch 22. This opening allows small contents to be inserted and removed, such as, but not limited to identification cards, automobile registration documents, and proof of insurance documents. To ease the process of removing and inserting documents listed above, the pouch 20 contains a hole through one face of pouch 26. This hole can be used to allow an individual to use their finger or thumb to slide the contents in or out of the pouch 20 more easily. The pouch 20 also contains some type of fastening mechanism 24, such as but not limited to hook and loop, non-damaging adhesive, magnets or combination thereof which is secured to the exterior of the pouch 20 on the side of the pouch 20 opposite the hole 26. This fastening mechanism 24 allows the pouch to be quickly affixed and removed from the hard surface, such as an automotive interior door panel or dashboard. In the preferred embodiment of the invention which utilizes hook and loop, either the hook or loop side will have to be secured to the hard surface via non-damaging adhesive. Then, the remaining entity of the hook and loop combination will be secured to the face of the pouch 20 via non-damaging adhesive allowing the hook and loop to hold the pouch 20 in place. In the case of the magnet, half of the magnet will be secured to the hard surface, while the remaining half will be secured to the face of the pouch 20 such that the magnet is capable of holding the pouch 20 in place on the hard surface. FIG. 2 shows a front view of a potential installation location of the present invention. A typical automobile interior door panel 12 contains a number of items including but not limited to an interior door panel arm rest 14, interior door panel door handle 16. Automobile window 10 is shown for reference. A potential installation location for the present invention 18 is shown that is easily accessible for the automobile driver, easily seen by an individual standing outside the driver's side door of the automobile, and is not in a position to catch an excessive amount of wind that could disturb the pouch 20 when the automobile window 10 is not in an up position. The pouch 20 should be oriented such that gravity and or wind don't pull the pouch contents out inadvertently.

### REFERENCE NUMERALS IN THE DRAWINGS ARE AS FOLLOWS

10—automobile window (shown partially rolled down)
12—automobile interior door panel
14—automobile interior door panel arm rest
16—automobile interior door panel door handle
18—potential installation location of present invention
20—pouch
22—opening on one edge of pouch
24—fastening mechanism of pouch, such as but not limited to hook and loop, non-damaging adhesive, magnet or combination thereof secured to one face of pouch
26—hole through one face of pouch

### SEQUENCE LISTING

Not Applicable

I claim:

1. A slim, unobtrusive, flexible, durable, water resistant pouch;
wherein the pouch includes a non-damaging/non-perforating method of mounting such as hook and loop, non-damaging adhesive, magnets or combination thereof, allowing the pouch to be quickly affixed to and removed from a hard surface, such as an interior door panel or dashboard of an automobile with one hand, without the use of tools or additional fasteners or clamping mechanisms;
wherein method of mounting won't damage or perforate the hard surface it is affixed to and can be removed/affixed thousands of times without degradation of performance;
wherein the pouch is capable of holding and sized appropriately for contents such as an Identification card, automotive registration and proof of insurance simultaneously;
wherein one edge of the pouch is open allowing quick removal and insertion of said contents without the use of tools;
wherein pouch contains a hole on one face allowing an individual to slide said contents out more easily using their finger or thumb.

2. A pouch which is lightweight, small, such that its profile is slim and unobtrusive, and can easily conform to the shape required to fit in one's pants, shirts, or shorts pocket, that secures its contents tightly and allows for the quick and easy insertion and removal of its contents without the use of tools;
wherein pouch includes a non-damaging/non-perforating method of quickly affixing and removing itself to a hard surface such as but not limited to hook and loop, non-damaging adhesive, magnets, or combination thereof which can be affixed and released by one hand without the use of tools to a hard surface such as an automotive door panel or dashboard.

3. A pouch which is lightweight, small, and constructed of durable and flexible material;
wherein pouch includes a non-damaging/non-perforating method of quickly affixing and removing itself to a hard surface such as but not limited to hook and loop, non-damaging adhesive, magnets, or combination thereof which can be affixed and released by one hand without the use of tools thousands of times without degradation of performance.
